(19) United States
(12) Patent Application Publication
(10) Pub. No.: US 2015/0130866 A1
(43) Pub. Date: May 14, 2015

(54) ORGANIC LIGHT-EMITTING DIODE (OLED) DISPLAY AND METHOD FOR DRIVING THE SAME

(71) Applicant: Samsung Display Co., Ltd., Yongin-city (KR)

(72) Inventors: Min-Seok BAE, Yongin-city (KR); Sang-Jin PAK, Yongin-city (KR); Joo-Hyung LEE, Yongin-city (KR); Sung-Hoon BANG, Yongin-city (KR)

(21) Appl. No.: 14/533,859

(22) Filed: Nov. 5, 2014

(30) Foreign Application Priority Data
Nov. 11, 2013 (KR) 10-2013-0136137

(51) Int. Cl. G09G 3/20; G09G 3/32

(52) U.S. Cl. CPC G09G 3/2007; G09G 3/3275; G09G 2320/045; G09G 2320/0233
USPC 345/694; 345/77

(57) ABSTRACT

An organic light-emitting diode (OLED) display and method for driving the same are disclosed. In one aspect, the OLED display includes a plurality of pixels and a compensation unit configured to receive first image data including a gray scale value for each pixel. The compensation unit accumulates the first image data to generate accumulated data, selects a data compensation method for each pixel based at least in part on the accumulated data, and compensates the gray scale value included in the first image data for each pixel based at least in part on the selected data compensation method to generate second image data. The OLED display also includes a data driver configured to convert the second image data into data signals and apply the data signals to the pixels.

### CROSS-REFERENCE TO RELATED APPLICATIONS

This application claims priority to and the benefit of Korean Patent Application No. 10-2013-0136137, filed on Nov. 11, 2013, in the Korean Intellectual Property Office, the entire contents of which are incorporated herein by reference in their entirety.

### BACKGROUND

1. Field

The described technology generally relates to an organic light-emitting diode (OLED) display and a method for driving the same.

2. Description of the Related Technology

Recently, various flat panel display technologies have been developed with reduced weights and volumes when compared to cathode ray tube (CRT) displays. Examples of such flat panel displays include liquid crystal displays (LCDs), field emission displays (FEDs), plasma display panels (PDPs), organic light-emitting diode (OLED) displays, and the like.

OLED displays produce images by emitting light from an organic emitting layer included in each of the OLEDs through the recombination of electrons and holes. OLED displays have favorable characteristics such as fast response speeds and low power consumption.

### SUMMARY OF CERTAIN INVENTIVE ASPECTS

One inventive aspect is an organic light-emitting diode (OLED) display and a method for driving the same which can compensate for pixel deterioration.

Another aspect is an OLED display including a compensation unit configured to determine a data compensation method corresponding to each pixel, based on accumulated data obtained by accumulating a first data supplied from an outside thereof, and generate a second data by converting a gray scale value corresponding to each pixel, based on the determined data compensation method, a data driver configured to supply the second data as data signals to the pixels through data lines, a measurement unit configured to sense current flowing through a driving transistor and/or an OLED in each pixel and output current information on the sensed current to the compensation unit.

The data compensation method may include a current compensation method using the current information and an accumulated data compensation method using the accumulated data.

The compensation unit may include a data accumulation unit configured to generate the accumulated data by accumulating the first data, a compensation method determining unit configured to compare accumulated values included in the accumulated data with a reference accumulated value and determine the data compensation method corresponding to each pixel, based on the compared result, and a data conversion unit configured to convert the first data into the second data, based on the data compensation method.

The reference accumulated value may be changed depending on the gray scale value corresponding to each pixel.

The variation of the reference accumulated value may be determined based on a signal-to-noise ratio of the measurement unit.

The compensation method determining unit may determine, as the current compensation method, the data compensation method corresponding to first pixels of which accumulated value is greater than the reference accumulated value, and determine, as the accumulated data compensation method, the data compensation method corresponding to second pixels of which accumulated value is less than the reference accumulated value.

The data conversion unit may limit, to a predetermined range, the conversion amount of the gray scale value corresponding to each pixel, to prevent overcompensation.

Another aspect is a method for driving an OLED display, the method including generating accumulated data by accumulating a first data supplied from an outside, determining a data compensation method corresponding to each pixel, based on accumulated value corresponding to each pixel included in the accumulated data, and converting the first data into a second data, based on the determined data compensation method, and supplying the converted second data to the pixels.

The data compensation method may be any one of a current compensation method of sensing current flowing through a driving transistor and/or an organic light emitting diode in each pixel and using current information on the sensed current, and an accumulated data compensation method using the accumulated data.

The determining may include comparing the accumulated value with a reference accumulated value, determining the data compensation method as the current compensation method when the accumulated value is greater than the reference accumulated value, and determining the data compensation method as the accumulated data compensation method when the accumulated value is less than the reference accumulated value.

The reference accumulated value may be changed depending on a gray scale value corresponding to each pixel.

The variation of the reference accumulated value may be determined based on a signal-to-noise ratio of the current information.

The data conversion amount when the first data is converted into the second data may be limited to a predetermined range, to prevent overcompensation.

Another aspect is an OLED display including a plurality of pixels, a measurement unit configured to measure current flowing through each of the pixels, and a compensator configured to receive first image data, accumulate the first image data, and selectively compensate the first image data for each pixel based at least in part on at least one of the accumulated data or the measured current.

The compensator is further configured to compensate the first image data with a data compensation method selected based at least in part on the accumulated data. The compensator is further configured to select a current compensation method comprising compensating the first image data based at least in part on the measured current or an accumulated data compensation method comprising compensating the first image data based at least in part on the accumulated data.

The compensator includes a data accumulator configured to receive the first image data and generate the accumulated data, a compensation method selection unit configured to receive the first image data and the accumulated data and generate a control signal indicating the selected data compensation method, and a data converter configured to receive the first image data, the accumulated data, the measured current, and the control signal and compensate the first image data based at least in part on the control signal and at least one of the accumulated data or the measured current.

The first image data includes a gray scale value for each pixel and wherein the compensation method selection unit is further configured to generate a reference accumulated value for each pixel based at least in part on the corresponding gray scale value, compare the accumulated value for each pixel to the corresponding reference accumulated value, and select the data compensation method for each pixel based at least in part on the comparison.

The first image data includes a gray scale value for each pixel and the compensator is further configured to selectively compensate the gray scale value for each pixel based at least in part on the corresponding accumulated data. The compensator is further configured to limit the compensation of the first image data to a predetermined range.

### BRIEF DESCRIPTION OF THE DRAWINGS

FIG. 1 is a block diagram illustrating an OLED display according to an embodiment.

FIG. 2 is a block diagram illustrating in detail the compensation unit shown in FIG. 1.

FIG. 3 is a flowchart illustrating a method for driving an OLED display according to an embodiment.

### DETAILED DESCRIPTION OF CERTAIN INVENTIVE EMBODIMENTS

Example embodiments will now be described more fully hereinafter with reference to the accompanying drawings. However, the described embodiments may be embodied in different forms and should not be construed as limited to the embodiments set forth herein. Rather, these embodiments are provided so that this disclosure will be thorough and complete and will fully convey the scope of the described technology to those skilled in the art.

In the figures, dimensions may be exaggerated for clarity of illustration. It will be understood that when an element is referred to as being “between” two elements, it can be the only element between the two elements, or one or more intervening elements may also be present. Like reference numerals refer to like elements throughout.

Hereinafter, certain exemplary embodiments will be described with reference to the accompanying drawings. Here, when a first element is described as being coupled or connected to a second element, the first element may be not only directly coupled or connected to the second element but may also be indirectly coupled or connected to the second element via a third element. Further, some of the elements that are not essential to the complete understanding of the described technology are omitted for clarity. Also, like reference numerals refer to like elements throughout.

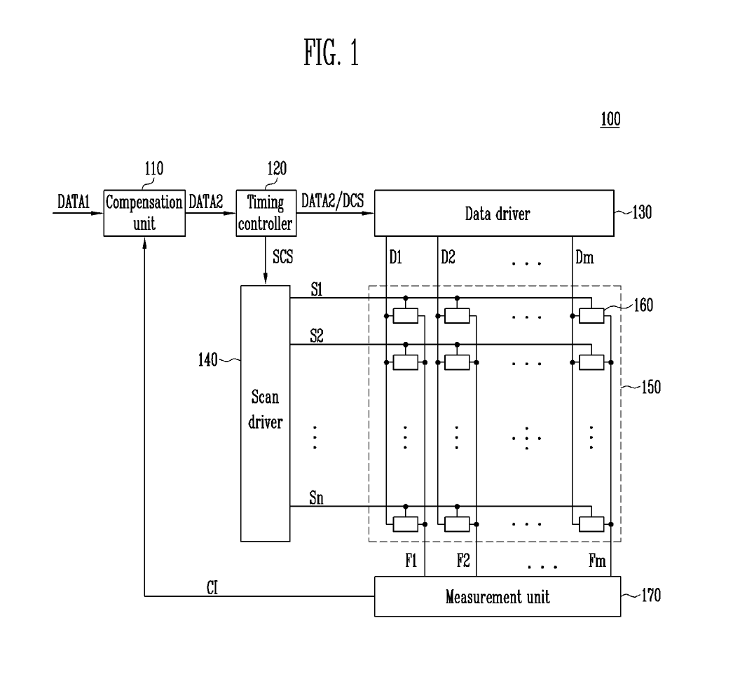

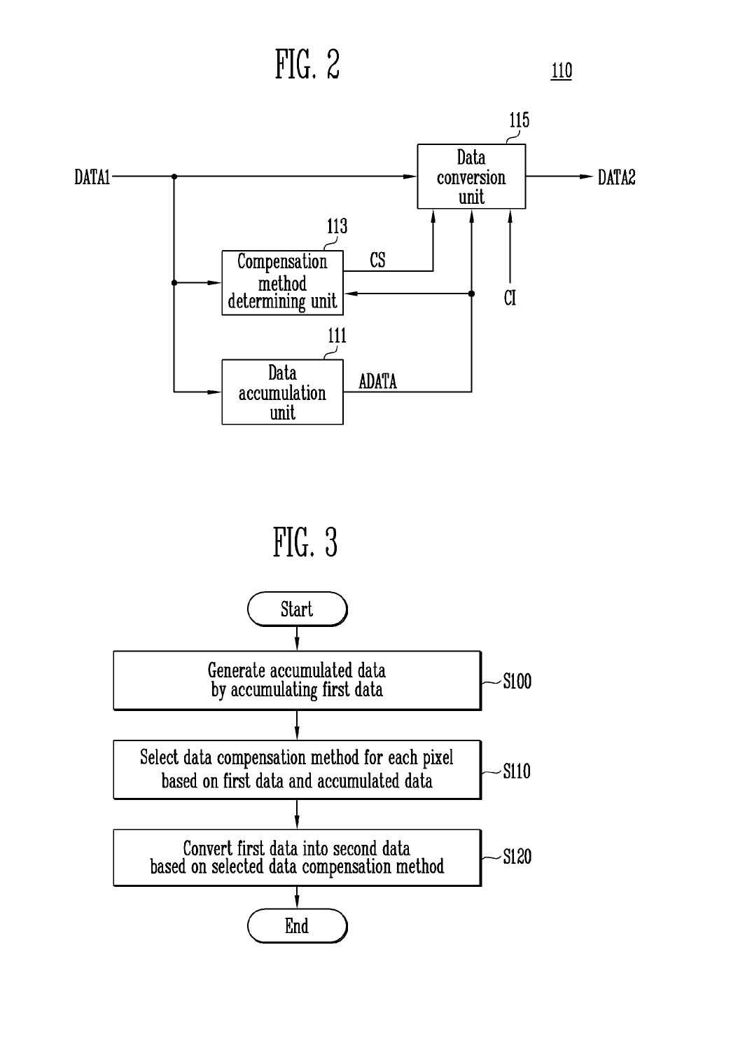

FIG. 1 is a block diagram illustrating an organic light-emitting diode (OLED) display according to an embodiment. FIG. 2 is a block diagram illustrating in detail the compensation unit shown in FIG. 1.

Referring to FIGS. 1 and 2, the OLED display 100 includes a compensation unit or compensator 110, a timing controller 120, a data driver 130, a scan driver 140, a display unit 150, and a measurement unit 170.

The compensation unit 110 converts first data or first image data DATA1 into second data or second image data DATA2 using a data compensation method determined based on accumulated data ADATA. The compensation unit 110 determines a data compensation method to be applied for each pixel 160 according to accumulated value corresponding to each pixel 160.

Specifically, the compensation unit 110 generates accumulated data ADATA by accumulating the first data DATA1 received from an external source. The compensation unit 110 compares accumulated value corresponding to each pixel 160 included in the accumulated data ADATA with a reference accumulated value and determines a data compensation method to be applied for each pixel 160 according to the compared result. The data compensation method includes at least one of a current compensation method or an accumulated data compensation method. That is, the compensation unit 110 determines which of the current compensation method or the accumulated data compensation method to be applied as the data compensation method for each pixel 160.

In this specification, the ‘current compensation method’ refers a method of measuring current flowing through a driving transistor and/or an OLED in each pixel 160 and compensating for image data using current information included in the measured current. In the current compensation method, the degree of degradation of the driving transistor and/or the OLED is directly measured through a current measurement, and thus, it is unnecessary to consider various other factors which have influence on the degradation of the driving transistor and/or the OLED. However, the current compensation method requires an additional time period for measuring the current, and may not be sufficiently precise due to measurement error caused by the characteristics of a current measurement circuit, e.g., the measurement unit 170.

In this specification, the ‘accumulated data compensation method’ refers to a method of estimating a degree of degradation of each pixel 160 using accumulated data ADATA obtained by accumulating an image data and compensating for the image data according to the estimated degradation degree. The accumulated data compensation method is independent on an error of a sensing result, e.g., an error caused by noise. However, the accumulated data compensation method does not consider changes in various factors that have influence on degradation of the pixels 160, and therefore may not be exact as the degradation of the pixels 160 is advanced.

The compensation unit 110 determines a data compensation method for each pixel 160 in order to precisely compensate for the degradation of each pixel 160. In some embodiments, when the accumulated value is greater than the reference accumulated value for a pixel, the compensation unit 110 uses the current compensation method as the data compensation method for the pixel. Alternately, when the accumulated value is less than the reference accumulated value for a pixel, the compensation unit 110 uses the accumulated data compensation method as the data compensation method for the pixel.

The reference accumulated value is set in consideration of the error of the measurement result. In some embodiments, the reference accumulated value is determined based on a signal-to-noise ratio characteristic of the measurement unit 170, i.e., a signal-to-noise ratio of current information CI. That is, if the measurement error of the measurement unit 170 is large, the current compensation method may not be precise when compared with the accumulated data compensation method. Therefore, when the measurement error is large, the reference accumulated value is preferably set high so that the application range of the accumulated data compensation method becomes wide. On the contrary, if the measurement error of the measurement unit 170 is small, the accumulated data compensation method may not be precise when compared with the current compensation method. Therefore, when the measurement error is small, the reference accumulated value is preferably set low so that the application range of the current compensation method becomes wide.

The reference accumulated value may be changed depending on a gray scale value corresponding to each pixel 160 included in the first data DATA1. Since the amplitude of measured current is small for low gray scale values, the measurement error caused by noise in the measurement increases for low gray scale value. Therefore, when the data compensation method for a pixel having a low gray scale value is determined, the compensation unit 110 sets the reference accumulated value to be high so that the application range of the accumulated data compensation method becomes wide. On the contrary, when the data compensation method for a pixel having a high gray scale value is determined, the compensation unit 110 sets the reference accumulated value to be low so that application range of the current compensation method becomes wide. The variation of the reference accumulated value is changed depending on a gray scale value and is determined based on the signal-to-noise ratio characteristics of the measurement unit 170.

The compensation unit 110 converts the first data DATA1 into the second data DATA2 based on the data compensation method determined with respect to each pixel 160. That is, the compensation unit 110 converts a gray scale value corresponding to each pixel 160 based on the determined data compensation method.

In some embodiments, the compensation unit 110 limits the difference between the first data DATA1 and the second data DATA2 to a predetermined range in order to prevent overcompensation. That is, the change in value from the first data DATA1 when converted into the second data DATA2 is limited to a predetermined range in order to prevent overcompensation.

The compensation unit 110 supplies the second data DATA2 to the timing controller 120.

The compensation unit 110 includes a data accumulation unit or data accumulator 111, a compensation method determining unit 113, and a data conversion unit or data converter 115.

The data accumulation unit 111 receives first data DATA1 from an external source, e.g., a host. The data accumulation unit 111 generates accumulated data ADATA by accumulating the first data DATA1. The data accumulation unit 111 outputs the accumulated data ADATA to the compensation method determining unit 113 and the data conversion unit 115.

The compensation method determining unit 113 receives the first data DATA1 from the external source and the accumulated data ADATA from the data accumulation unit 111. The compensation method determining unit 113 determines a data compensation method corresponding to each pixel 160 based on the first data DATA1 and the accumulated data ADATA.

The compensation method determining unit 113 determines reference accumulated values corresponding to each of the pixels 160 based on gray scale values included in the first data DATA1. Subsequently, the compensation method determining unit 113 compares accumulated values included in the accumulated data ADATA with the reference accumulated values and determines a data compensation method for each pixel 160 based on the result of the comparison. The compensation method determining unit 113 outputs the determined data compensation method as a control signal CS to the data conversion unit 115.

The data conversion unit 115 receives the first data DATA1 from the external source, the control signal CS from the compensation method determining unit 113, and current information CI from the measurement unit 170. The data conversion unit 115 applies the determined data compensation method for each pixel 160 to the first data DATA1 in response to the control signal CS. That is, the data conversion unit 115 converts the first data DATA1 into second data DATA2 based on the determined data compensation method for each pixel 160. The data conversion unit 115 outputs the second data DATA2 to the timing controller 120.

The timing controller 120 controls operations of the data driver 130 and the scan driver 140 in response to a synchronization signal (not shown) received from an external source. Specifically, the timing controller 120 generates a data driving control signal DCS and supplies the generated data driving control signal DCS to the data driver 130. The timing controller 120 generates a scan driving control signal SCS and supplies the generated scan driving control signal SCS to the scan driver 140. The timing controller 120 supplies the second data DATA2 received from the compensation unit 110 to the data driver 130.

The data driver 130 realigns the second data DATA2 received from the timing controller 120 in response to the data driving control signal DCS and applies the realigned second data DATA2 as data signals to data lines D1 to Dm.

The scan driver 140 progressively supplies scan signals to scan lines 51 to Sn in response to the scan driving control signal SCS received from the timing controller 120.

The display unit 150 includes pixels 160 respectively formed at intersections between the data lines D1 to Dm, feedback lines F1 to Fm, and the scan lines 51 to Sn. In the embodiment of FIG. 1, the data lines D1 to Dm and the feedback lines F1 to Fm are arranged in a vertical direction and the scan lines S1 to Sn are arranged in a horizontal direction.

Each pixel 160 emits light with luminance corresponding to a data signal received through a corresponding data line among the data lines D1 to Dm. Each pixel 160 supplies a current including degradation information of the driving transistor or OLED to the measurement unit 170 through the feedback lines F1 to Fm.

The measurement unit 170 measures the current received from the pixels 160 through the feedback lines F1 to Fm and supplies current information CI corresponding to the measured current values to the compensation unit 110.

Although it has been illustrated in FIG. 1 that the current supplied from the pixels 160 flows into the measurement unit 170 through the feedback lines F1 to Fm, the described technology is not limited thereto. In some embodiments, the currents supplied from the pixels 160 flows into the measurement unit 170 through the data lines D1 to Dm.

FIG. 3 is a flowchart illustrating a method for driving the OLED display according to an embodiment. In some embodiments, the method of FIG. 3 is implemented in a conventional programming language, such as C or C++ or another suitable programming language. The program can be stored on a computer accessible storage medium of the display 100, for example, in a memory included in the compensation unit 110. In certain embodiments, the storage medium includes a random access memory (RAM), hard disks, floppy disks, digital video devices, compact discs, video discs, and/or other optical storage mediums, etc. The program may be stored in a processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor can execute applications with the assistance of operating systems such as Unix, Linux, Microsoft DOS, Microsoft Windows 7/Vista/2000/9×/ME/XP, Macintosh OS, OS/2, Android, iOS and the like. In another embodiment, at least part of the method can be implemented with embedded software. Depending on the embodiment, additional states may be added, others removed, or the order of the states changed in FIG. 3.

Referring to FIG. 3, the data accumulation unit 111 generates accumulated data ADATA by accumulating image data, i.e., first data DATA1 received from an external source (S100).

The compensation method determining unit 113 selects a data compensation method for each pixel 160 based on the first data DATA1 and the accumulated data ADATA (S110). The compensation method determining unit 113 selects one of the current compensation method or the accumulated data compensation method as a data compensation method for each pixel 160 based on accumulated value corresponding to each pixel 160 and a reference accumulated value. The compensation method determining unit 113 sets the reference accumulated value based on the gray scale value included in the first data DATA1 corresponding to each pixel 160. In some embodiments, the reference accumulated value is changed by the compensation method determining unit 113.

The data conversion unit 115 generates second data DATA2 by converting gray scale values included in the first data DATA1 based on the data compensation method selected by the compensation method determining unit 113 (S120). The data conversion unit 115 supplies the second data DATA2 to the timing controller 120.

The timing controller 120 supplies the second data DATA2 to the pixels 160 through the data driver 130. Each pixel 160 emits light corresponding to the second data DATA2 in which the degradation of each pixel 160 is compensated for so that the display unit 150 can display a compensated image.

By way of summation and review, the characteristics of an OLED and a driving transistor applying current to the OLED may be degraded as the OLED and the driving transistor age. When the OLED or the driving transistor degrades, a pixel does not emit light with a precise luminance corresponding to the data signal applied to the pixel. Therefore, the quality of an image displayed may suffer.

In the OLED display and the method for driving the same according to at least one embodiment, the data compensation method of each pixel is determined based on accumulated data so that the degradation of the pixel can be more precisely compensated for.

Exemplary embodiments have been disclosed herein, and although specific terms are employed, they are used and are to be interpreted in a generic and descriptive sense only and not for the purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An organic light-emitting diode (OLED) display, comprising:
a plurality of pixels;
a compensation unit configured to i) receive first image data including a gray scale value for each pixel, ii) accumulate the first image data to generate accumulated data, iii) select a data compensation method for each pixel based at least in part on the accumulated data, and iv) compensate the gray scale value included in the first image data for each pixel based at least in part on the selected data compensation method to generate second image data; and
a data driver configured to convert the second image data into data signals and apply the data signals to the pixels.

2. The OLED display of claim 1, further comprising a measurement unit configured to measure current flowing through each pixel and output current information to the compensation unit, wherein the compensation unit is further configured to select i) a current compensation method comprising compensating the first image data based at least in part on the current information or ii) an accumulated data compensation method comprising compensating the first image data based at least in part on the accumulated data.

3. The OLED display of claim 2, wherein the compensation unit includes:
a data accumulation unit configured to generate the accumulated data;
a compensation method determining unit configured to compare accumulated values included in the accumulated data to a reference accumulated value for each pixel and select the data compensation method for each pixel based at least in part on the comparison; and
a data conversion unit configured to convert the first image data into the second image data based at least in part on the selected data compensation method.

4. The OLED display of claim 3, wherein the compensation method determining unit is further configured to change the reference accumulated value based at least in part on the gray scale value included in the first image data for each pixel.

5. The OLED display of claim 4, wherein the compensation method determining unit is further configured to change the reference accumulated value based at least in part on a signal-to-noise ratio of the current information.

6. The OLED display of claim 3, wherein the compensation method determining unit is further configured to i) select the current compensation method for a pixel when the accumulated value for the pixel is greater than the reference accumulated value and ii) select the accumulated data compensation method for the pixel when the accumulated value for the pixel is less than the reference accumulated value.

7. The OLED display of claim 3, wherein the data conversion unit is further configured to limit the compensation of the gray scale values to a predetermined range.

8. A method for driving an organic light-emitting diode (OLED) display including a plurality of pixels, the method comprising:
receiving first image data;
accumulating the first image data as accumulated data;
selecting a data compensation method for each pixel based at least in part on the accumulated data;
converting the first image data into a second image data based at least in part on the selected data compensation method; and
applying the second image data to the pixels.

9. The method of claim 8, wherein the selecting comprises selecting one of i) a current compensation method comprising compensating the first image data based at least in part on current flowing through each pixel or ii) an accumulated data compensation method comprising compensating the first image data based at least in part on the accumulated data.

10. The method of claim 9, wherein the selecting includes:
comparing an accumulated value for each pixel with a reference accumulated value;
selecting the current compensation method as the data compensation method when the accumulated value is greater than the reference accumulated value; and
selecting the accumulated data compensation method as the data compensation method when the accumulated value is less than the reference accumulated value.

11. The method of claim 10, further comprising changing the reference accumulated value for each pixel based at least in part on a corresponding gray scale value included in the first image data.

12. The method of claim 11, wherein the changing further comprises changing the reference accumulated value based at least in part on a signal-to-noise ratio of the current information.

13. The method of claim 8, wherein the converting is limited to a predetermined range.

14. An organic light-emitting diode (OLED) display, comprising:
a plurality of pixels;
a measurement unit configured to measure current flowing through each of the pixels; and
a compensator configured to i) receive first image data, ii) accumulate the first image data, and iii) selectively compensate the first image data for each pixel based at least in part on at least one of the accumulated data or the measured current.

15. The OLED display of claim 14, wherein the compensator is further configured to compensate the first image data with a data compensation method selected based at least in part on the accumulated data.

16. The OLED display of claim 15, wherein the compensator is further configured to select i) a current compensation method comprising compensating the first image data based at least in part on the measured current or ii) an accumulated data compensation method comprising compensating the first image data based at least in part on the accumulated data.

17. The OLED display of claim 16, wherein the compensator comprises:
a data accumulator configured to receive the first image data and generate the accumulated data;
a compensation method selection unit configured to receive the first image data and the accumulated data and generate a control signal indicating the selected data compensation method; and
a data converter configured to i) receive the first image data, the accumulated data, the measured current, and the control signal and ii) compensate the first image data based at least in part on the control signal and at least one of the accumulated data or the measured current.

18. The OLED display of claim 17, wherein the first image data includes a gray scale value for each pixel and wherein the compensation method selection unit is further configured to i) generate a reference accumulated value for each pixel based at least in part on the corresponding gray scale value, ii) compare the accumulated value for each pixel to the corresponding reference accumulated value, and iii) select the data compensation method for each pixel based at least in part on the comparison.

19. The OLED display of claim 15, wherein the first image data includes a gray scale value for each pixel and wherein the compensator is further configured to selectively compensate the gray scale value for each pixel based at least in part on the corresponding accumulated data.

20. The OLED display of claim 14, wherein the compensator is further configured to limit the compensation of the first image data to a predetermined range.
